(19) United States
(12) Patent Application Publication
(10) Pub. No.: US 2014/0204596 A1
(43) Pub. Date: Jul. 24, 2014

(54) THEFTPROOF LAMP

(71) Applicant: Yunfei Xu, Shanghai (CN)

(72) Inventor: Yunfei Xu, Shanghai (CN)

(73) Assignee: KONINKLIJKE PHILIPS N.V., EINDHOVEN (NL)

(21) Appl. No.: 14/236,084

(22) PCT Filed: Jul. 25, 2012
(86) PCT No.: PCT/IB12/53773

§ 371 Date: Jan. 30, 2014

(30) Foreign Application Priority Data
Aug. 2, 2011 (CN) PCT/CN2011/001266

(51) Int. Cl. F21V 15/00; F21V 17/10

(52) U.S. Cl. CPC F21V 15/005; F21V 17/10
USPC 362/378

(57) ABSTRACT

A theftproof lamp (100), including a lamp body (110) and a lamp cap (120). A spring member (140) and a ratchet wheel mechanism (130) are provided inside the lamp for cooperating with each other and enabling theftproof effect. When turning the lamp clockwise, the lamp can be screwed down to a lamp socket. When turning the lamp counter-clockwise, the lamp can only make repetitive circular motions around the ratchet wheel and therefore achieve the theftproof effect. When a user needs to remove the lamp in a safe way, a bolt (170) can be moved inwardly to block the spring member from moving upward, so that the lamp body, ratchet wheel and lamp cap form a whole, without any movement in relation to each other, and therefore allowing easy removal of the lamp.

### BACKGROUND

1. Technical Field

The present invention generally relates to the field of lighting, specifically to a theftproof lamp.

2. Brief Description of Prior Arts

It is known in the lighting field that high-end lamps can be very expensive, such as those installed in large stadiums or luxury hotels. Accordingly, these expensive lamps face the risk of being stolen. Typical theftproof CFL structures are quite complex, because CFL can provide bigger rooms and simpler electrical circuits for the complex structure. For example, an annular CFL is provided with a thick enough and long enough needle inside for unlocking the theftproof lock. Another shortcoming of these theftproof CFL structures lies in their elastic sheet, which is pushed down and rises up when the lamp is being turned in one direction and cannot be taken away without the key (the long and thick needle). In addition, the elastic sheet is easily worn out and loses its elasticity and doesn't work again. Therefore, when real users try to take the CFL off from the lamp holder by turning the lamp, the lamp cannot be taken away and can only make repetitive circular motion.

### SUMMARY OF THE PRESENT INVENTION

One objective of the present invention is to furnish a theftproof lamp that has a simple structure and is less likely to fail when the lamp needs to be removed from a fixture by real users, instead of thieves.

According to the present invention, the theftproof lamp includes a lamp base and a lamp body. The lamp body includes a spring member. The lamp base includes a ratchet wheel and an exterior surface configured to mechanically engage with a lamp socket. The spring member is configured to mechanically engage with the ratchet wheel to allow the lamp body and the lamp base to rotate only in one direction with respect to one another. When turning the lamp clockwise, the lamp can be screwed down to the lamp holder. When turning the lamp counter-clockwise, the lamp can only make repetitive circular motion around the ratchet wheel mechanism and therefore cannot be taken away.

In some embodiments of the present invention, when the real users need to take away the lamp, a bolt in the spring member can be adjusted to block a needle-like structure in the spring member, which is engaged with the ratchet wheel mechanism, so that the lamp can be taken away in a safe way.
a. Any of the embodiments of the present invention can realize one or more of the following advantages: The combination of the ratchet wheel mechanism and the spring member is reliable for use and prevents the failure of taking away lamps when real users need to do that in a safe way.
b. The ratchet wheel and the spring member both have a simple structure, which is not only good for conventional lamps, which can provide large internal spaces, but also for LED lamps, which can have complex electrical circuits and, therefore, smaller internal space.

### BRIEF DESCRIPTION OF DRAWINGS

FIG. 1 is a schematic illustrating the internal structure of a lamp according some embodiments of the present invention.

FIG. 2 is a schematic illustrating the internal structure of the spring member of some embodiments of the present invention.

FIG. 3 is a schematic illustrating the internal structure of the ratchet wheel mechanism of some embodiments of the present invention.

### DETAILED DESCRIPTION OF PREFERRED EMBODIMENTS

Embodiments of the present invention will be described more fully hereinafter with reference to the accompanying drawings, in which embodiments of the invention are shown. This invention can, however, be embodied in many different forms and should not be construed as limited to the embodiments set forth herein. Like numbers refer to like elements throughout.

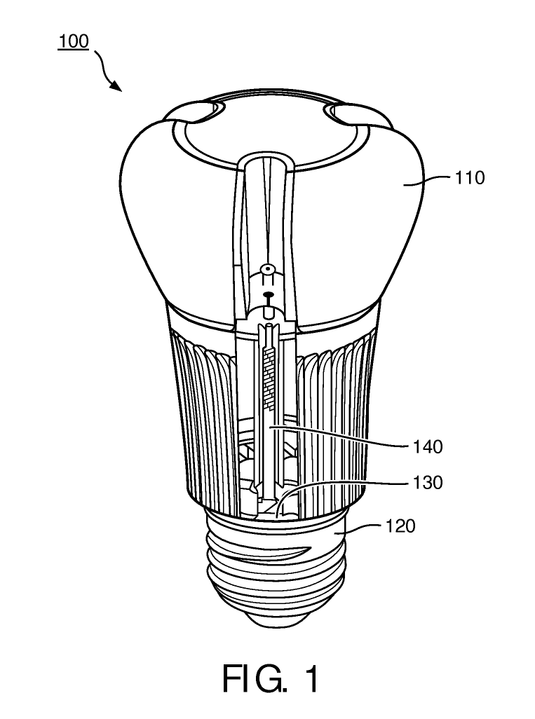

FIG. 1 is a schematic illustrating the internal structure of a lamp 100 according to some embodiments of the present invention. As FIG. 1 shows, the embodiment takes a LED lamp 100 as an example to show that even in a complex LED lamp, the simple structure of the present invention can be implemented therein. The LED lamp 100 includes a lamp body 110 (e.g., a light-emitting portion and/or a portion containing driver electronics) and a lamp cap 120 (e.g., a base configured to mechanically engage with a socket of a fixture). A ratchet wheel mechanism 130 is provided, for example, at the joining part of the lamp body 110 and the lamp cap 120. In some embodiments, the ratchet wheel mechanism 130 can be positioned within the lamp cap 120 and/or within the lamp body 110. The ratchet wheel mechanism 130 can be fixed to the lamp cap 120. A spring member 140 is provided above the ratchet wheel mechanism. In some embodiments, lamp 100 can include more than one spring member 140.

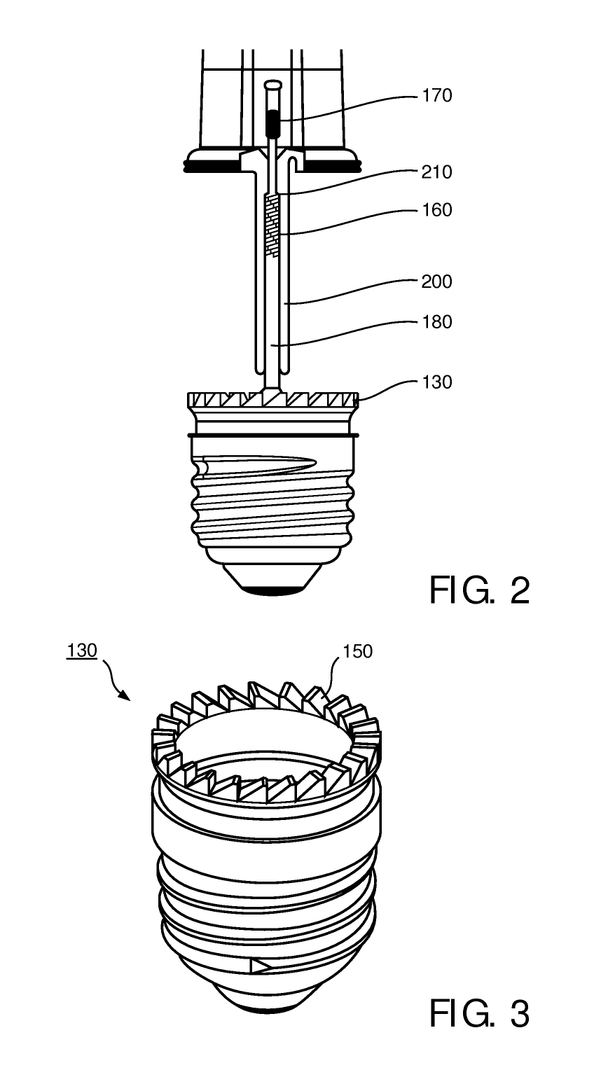

FIG. 2 is a schematic illustrating the internal structure of the spring member 140 of some embodiments of the present invention. FIG. 3 is a schematic illustrating the internal structure of the ratchet wheel mechanism 130 of some embodiments of the present invention. In some embodiments, the ratchet wheel mechanism 130 is a ratchet wheel with multiple sloping teeth 150. Each of the sloping teeth 150 has a vertical surface and a sloping surface. In some embodiments, only a subset of the sloping teeth 150 have vertical surfaces. The spring member 140 includes a spring 160 set in the lamp body 110, a bolt 170 capable of being positioned within or close to the spring 160, and a needle-like structure 180 with the upper part being wrapped up by the spring 160 and the lower part located underneath the spring. The bolt 170 can be inserted into the spring 160 from outside. In some embodiments, at least a portion of the bolt 170 is fixed on the outside surface of the lamp body 110. The spring 160 can be positioned at an upper part of the needle-like structure 180 so that it elastically engages with the needle-like structure 180. For example, the diameter of the upper part of the needle-like structure 180 can be thinner than the inside diameter of the spring. The diameter of the lower part of the needle-like structure 180 can be larger than the outside diameter of the spring. In general, the needle-like structure can include any elongated structure such as, for example, a cylinder. A protective sleeve 200 can be fixed on the inner surface of the lamp body 110 and can cover the spring member 140.

The lower part of the needle-like structure 180 can be configured in a shape to engage with the ratchet wheel 130. For example, the lower part of the needle-like structure 180 can include a vertical surface to engage with the vertical surfaces of the sloping teeth 150. The lower part of the needle-like structure 180 can also include a sloping surface to engage with the sloping surfaces of the sloping teeth 150.

In some embodiments, the lamp body 110 and the lamp cap 120 are fixed together in a direction parallel to the spring member 140 (e.g., the lamp body 110 and the lamp cap 120 are not free to come apart in an axial direction, but may be free to be rotatable with respect to one another). When the lamp 100 is turned clockwise, from the perspective of looking down on the lamp body 110, the vertical surfaces of the sloping teeth 150 can prevent the lamp body 110 and the lamp cap 120 from rotating with respect to one another. Accordingly, clockwise rotation of the lamp body 110 will force a similar clockwise rotation of the lamp cap 120, thereby allowing the lamp cap 120 to engage mechanically with a compatibly-sized lamp socket.

On the other hand, when the lamp 100 is turned counter-clockwise, the needle-like structure 180 can engage with the sloping surface of any sloping tooth 150, which will exert an upward force on the needle-like structure 180 and push the needle-like structure 180 upward and over the sloping tooth 150. Because the spring 160 can be elastically in contact with the needle-like structure 180 and a blocking structure 210 can be set either on an internal surface of the lamp body 110 or on an internal surface of the protective sleeve 200, the spring is blocked by the blocking structure 210 and therefore generates a counterforce to push the needle-like structure 180 into another adjacent tooth 150. The blocking structure 210 in some embodiments is disposed on the internal surface of the protective sleeve 200. By allowing the needle-like structure 180 to move upward and over the sloping teeth 150, the lamp body 110 and the lamp cap 120 will rotate with respect to one another. Accordingly, rotation of the lamp 100 in the counter-clockwise direction will not result in any movement in the lamp cap 120 and, therefore, removal of the lamp 100 by, e.g., a thief from the fixture can be prevented.

In some embodiments, the lamp body 110 can be allowed to be removed from the lamp socket in a safe way, without damaging the lamp. By allowing the lamp body 110 to be removable from a socket, the lamp can be repaired and/or changed. The lamp body 110 can include a hole set on an outside surface of the lamp body 110. The bolt 170 can extend from the hole into the internal space of the lamp body 110, e.g., into the spring 160. In an anti-theft state, the bolt 170 is positioned at a minimum distance away from the needle-like structure 180 such that it will not come into contact with the needle-like structure 180, even if the needle-like structure 180 is pushed upward by the sloping surface of the sloping teeth 150. However, when users need to disengage the lamp from the lamp holder (e.g., unscrew), the bolt 170 can be moved (e.g., turned and/or pushed) inwardly a sufficient distance to prevent the needle-like structure 180 from being pushed upwards by the sloping surfaces of the ratchet wheel 130. In the removal state, the resistance of the bolt 170 will not allow the needle-like structure 180 to move over the sloping teeth 150. Therefore, when the lamp 100 is turned counter-clockwise while in a removal state, the resistance provided by the bolt 170 can prevent the lamp body 110 and the lamp cap 120 from rotating with respect to one another. Accordingly, counter-clockwise rotation of the lamp body 110 in the removal state will force a similar counter-clockwise rotation of the lamp cap 120, thereby allowing the lamp cap 120 to disengage mechanically with the lamp socket.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements other than those listed in a claim. The word “a” or “an” preceding an element does not exclude the presence of a plurality of such elements.

1. A lamp comprising:
a lamp body including a spring member; and
a lamp base including a ratchet wheel and an exterior surface configured to mechanically engage with a lamp socket, wherein the spring member is configured to mechanically engage with the ratchet wheel to allow the lamp body and the lamp base to rotate only in one direction with respect to one another, wherein the spring member is configured so as to be constrained from axial movement.

2. The lamp of claim 1, wherein the ratchet wheel comprises a plurality of sloping teeth each having a vertical side surface and a sloping side surface, the ratchet wheel is fixed together with the lamp base.

3. The lamp of claim 1, wherein the spring member comprises:
a spring positioned in the lamp body;
a movable bolt fixed on an outside surface of the lamp body and including a portion that extends beyond the lamp body, the movable bolt configured to be inserted into or next to the spring; and
an elongated structure including an upper part positioned within the spring and a lower part located underneath the spring, wherein when the movable bolt is inserted into or next to the spring the elongated structure is constrained from axial movement.

4. The lamp of claim 3, wherein the diameter of the upper part of the elongated structure is thinner than the inside diameter of the spring, and wherein the diameter of the lower part of the elongated structure is larger than the outside diameter of the spring.

5. The lamp of claim 3, further comprising a protective sleeve covering the spring member.
